(19) United States
(12) Patent Application Publication
(10) Pub. No.: US 2011/0058824 A1
(43) Pub. Date: Mar. 10, 2011

(54) IMAGE FORMING APPARATUS

(76) Inventors: Kiyofumi Morimoto, Osaka (JP); Takeshi Ohkawa, Osaka (JP); Motoyuki Itoyama, Osaka (JP); Hideji Saikoh, Osaka (JP)

(21) Appl. No.: 12/855,022

(22) Filed: Aug. 12, 2010

(30) Foreign Application Priority Data
Sep. 8, 2009 (JP) 2009-206886

(51) Int. Cl. G03G 15/08

(52) U.S. Cl. 399/27

(57) ABSTRACT

An image forming apparatus includes: a developing device; a toner supply device that supplies toner to the developing device; a toner concentration controller that directs the toner supply device to perform toner supply to the developing device; and a toner empty determiner for determining that no toner is left in the toner supply device. The developing device includes a toner supply detecting sensor that detects whether toner is supplied from the toner supply device into the developer container, in the developer container. The toner concentration controller gives directions to perform the toner supply when the toner concentration of the developer in the developing device has become lower than a predetermined level. The toner empty determiner determines that the toner supply device has no toner left therein when no effect of the toner supply is detected by the toner supply detecting sensor after the toner supply is directed by the toner concentration controller. The toner supply detecting sensor is disposed in the preliminary agitating section.

This Nonprovisional application claims priority under 35 U.S.C. §119 (a) on Patent Application No. 2009-206886 filed in Japan on 8 Sep. 2009, the entire contents of which are hereby incorporated by reference.

### BACKGROUND OF THE INVENTION

(1) Field of the Invention

The present invention relates to an image forming apparatus, in particular relating to an image forming apparatus such as an electrostatic copier, laser printer, facsimile machine or the like that includes a developing device using a dual-component developer containing a toner and a magnetic carrier and forms images using toner based on electrophotography.

(2) Description of the Prior Art

Conventionally, image forming apparatuses based on electrophotography such as copiers, printers, facsimile machines and the like have been known. The image forming apparatus using electrophotography is constructed so as to form an image by forming an electrostatic latent image on the surface of a photoreceptor, e.g., photoreceptor drum, supplying toner to the photoreceptor drum from a developing device to develop the electrostatic latent image, transferring the toner image formed on photoreceptor drum by development to a sheet of paper etc., and fixing the toner image onto the sheet by means of a fixing device.

Recently, in the image forming apparatuses supporting full-color and high-quality images, a dual-component developer (which will be referred to hereinbelow simply as “developer”), which presents excellent charge performance stability, is often used.

This developer consists of a toner and a carrier, which are agitated in the developing device and frictionally rubbed with each other to thereby produce appropriately electrified toner.

The electrified toner in the developing device is supplied to a dual-component developer supporting member, e.g., the surface of a developing roller. The toner thus supplied to the developing roller is moved by electrostatic attraction to the electrostatic latent image formed on the photoreceptor drum. Hereby, a toner image based on the electrostatic latent image is formed on the photoreceptor drum.

Further, recently, image forming apparatuses are demanded to be made compact and operate at high speeds, hence it is necessary to electrify the developer quickly and sufficiently and also convey the developer quickly and smoothly. For this purpose, a preliminary agitating portion is provided in order to efficiently agitate and mix supplied toner with the developer.

In order to disperse supplied toner promptly into the developer and provide the toner with an appropriate amount of charge, a circulating type developing device has been adopted in some image forming apparatuses.

This circulating type developing device includes: a developer conveying passage in which the developer is circulatively conveyed; a screw auger (developer conveying member) for conveying the developer while agitating in the developer conveying passage; a toner supply port for leading toner from a toner container into the developer conveying passage; a preliminary agitating portion for efficiently agitating and mixing supplied toner with the developer; and a toner concentration detecting sensor for detecting the toner concentration of the developer. In this arrangement, when the toner concentration of the developer becomes lower than a predetermined level, toner supply is directed to the toner cartridge so that toner is supplied to the developer conveying passage and the supplied toner is conveyed whilst being agitated (see Patent Document 1: Japanese Patent Application Laid-open 2006-106194).

In the aforementioned circulating type developing device using the dual-component developer, if toner to be supplied from the toner cartridge is used up, the toner concentration in the developer gradually decreases. Since the occurrence of carrier phenomena (carrier adherence) to the photoreceptor drum increases with the decrease of toner concentration, it is necessary to perform toner empty detection.

Toner empty detection is to determine (detect) the occurrence of a state of toner empty when the toner concentration of the developer detected by the toner supply detecting sensor does not increase even after toner supply was directed to the toner cartridge.

However, if the toner concentration detecting sensor is located away from the toner supply port through which toner is supplied, detection of toner empty is delayed because the fall of toner concentration detected by the toner concentration detecting sensor is sluggish upon the toner empty detecting process. Further, in a case where the developing vessel is equipped with a preliminary agitating portion, the toner is agitated and mixed in a more efficient manner, it becomes more difficult to detect toner empty if the position of the toner sensor is away from the toner supply port, hence there occurs the problem that the occurrence of carrier adherence becomes more frequent.

### SUMMARY OF THE INVENTION

The present invention has been devised in view of the above problem, it is therefore an object of the present invention to provide an image forming apparatus that can immediately detect an empty state of toner to be supplied to the developing device and can prevent the occurrence of carrier adherence to the photoreceptor due to decrease in toner concentration.

According to the present invention, the image forming apparatus for solving the above problem is configured as follows:

The first aspect of the present invention resides in an image forming apparatus comprising: a developing device; a toner supply device that supplies toner to the developing device; a toner concentration controller that directs the toner supply device to perform toner supply to the developing device; and, a toner empty determiner for determining that no toner is left in the toner supply device, and is characterized in that the developing device comprises: a developer container for storing a developer including the toner and a magnetic carrier; a developer conveying assembly disposed inside the developer container for circulatively conveying the developer whilst agitating; a developing roller for supplying the toner contained in the developer to a photoreceptor drum; a toner supply port that leads the toner supplied from the toner supply device into the developer container; a preliminary agitating structure for agitating and mixing the supplied toner; and, a toner supply detecting sensor for detecting whether the toner is supplied from the toner supply device into the developer container, the toner concentration controller gives directions to perform the toner supply when the toner concentration of the developer in the developing device has become lower than a predetermined level, the toner empty determiner determines that the toner supply device has no toner left therein when no effect of the toner supply is detected by the toner supply detecting sensor after the toner supply is directed by the toner concentration controller, and the toner supply detecting sensor is disposed in the preliminary agitating section.

The second aspect of the present invention is characterized in that the toner supply detecting sensor detects the magnetic permeability of the developer residing in the preliminary agitating section.

The third aspect of the present invention is characterized in that the developer container includes a first conveying passage and a second conveying passage that are sectioned by a partitioning wall and arranged to communicate with each other at both ends of the partitioning wall, the developer conveying assembly includes a first conveying member and second conveying member that are arranged in the first convening passage and second conveying passage, respectively, agitate and circulatively convey the developer in the first conveying passage and second conveying passage, in opposite directions to each other, the developing roller supplies the toner inside the second conveying passage to the photoreceptor drum, the preliminary agitating section is arranged at a communicating portion that provides communication between the first conveying passage and the second conveying passage, the preliminary agitating section includes a preliminary agitating structure that conveys the developer whilst agitating, and the toner supply detecting sensor is disposed at the bottom of the preliminary agitating section under the toner supply port.

The fourth aspect of the present invention is characterized in that the preliminary agitating structure includes a screw auger having a rotary shaft and a helical blade that is formed so that the inclined angle relative to the axial direction of the rotary shaft (the angle formed between the rotary shaft and the outer peripheral edge of the helical blade when the rotary shaft is viewed along the axis) is specified to fall within the range of 30 degrees to 60 degrees.

The fifth aspect of the present invention further includes a dot counter for counting dots of data corresponding to image data to be transmitted to the exposure device (e.g. laser scanner unit) for forming an electrostatic latent image on the photoreceptor drum surface, and is characterized in that the toner concentration controller directs the toner supply device to supply toner to the developing device depending on the count of the dots of data from the dot counter.

For example, when the number of dots of data counted by the dot counter is small, the toner concentration controller may direct the toner supply device to supply a small amount of toner to developing device. When a large number of dots of data are counted, the controller may direct the toner supply device to supply a large amount of toner to the developing device. It is preferable that the amount of toner to be supplied has been specified in advance in relation with the condition of dots of data.

According to the first aspect of the present invention, since the toner supply detecting sensor detects presence or absence of toner supply immediately after directing toner to be supplied to the toner supply device, it is possible to detect toner empty and hence prevent the occurrence of carrier adherence due to a decrease in toner concentration when toner in the toner supply device is used up.

According to the second aspect of the present invention, it is possible to detect the effect of toner supply by detecting change in toner concentration.

According to the third aspect of the present invention, the effect of toner supply can be detected with precision. Specifically, since the pressure on the developer becomes maximum at the bottom of the pre-agitating section, voids are unlikely to form inside the developer. Accordingly it is possible to precisely detect the effect of toner supply with the toner supply detecting sensor.

According to the fourth aspect of the present invention, since the force for agitating the developer in the rotational direction of the pre-agitating member can be enhanced so that the “floating toner” phenomenon, the phenomenon of the added toner being conveyed floating over the developer, is unlikely to occur, it is possible for the toner supply detecting sensor to precisely detect the effect of toner supply.

According to the fifth aspect of the present invention, since it is possible to perform toner supply in a more exact manner compared to toner concentration control based on the toner concentration detected by the toner concentration detecting sensor, it is possible to perform toner concentration control and detection of toner empty, more precisely.

### BRIEF DESCRIPTION OF THE DRAWINGS

FIG. 1 is an illustrative view showing the overall configuration of an image forming apparatus according to the embodiment of the present invention;

FIG. 2 is a sectional view showing a schematic configuration of a toner supply device that constitutes the image forming apparatus;

FIG. 3 is a sectional view cut along a plane D1-D2 in FIG. 2;

FIG. 4 is a sectional view showing a configuration of a developing device that constitutes the image forming apparatus;

FIG. 5 is a sectional view cut along a plane A1-A2 in FIG. 4;

FIG. 6 is a sectional view cut along a plane B1-B2 in FIG. 4;

FIG. 7 is a sectional view cut along a plane C1-C2 in FIG. 5; and,

FIG. 8 is a block diagram showing a configuration of a control system in the image forming apparatus.

### DESCRIPTION OF THE PREFERRED EMBODIMENTS

Now, the embodied mode for carrying out the present invention will be described with reference to the drawings.

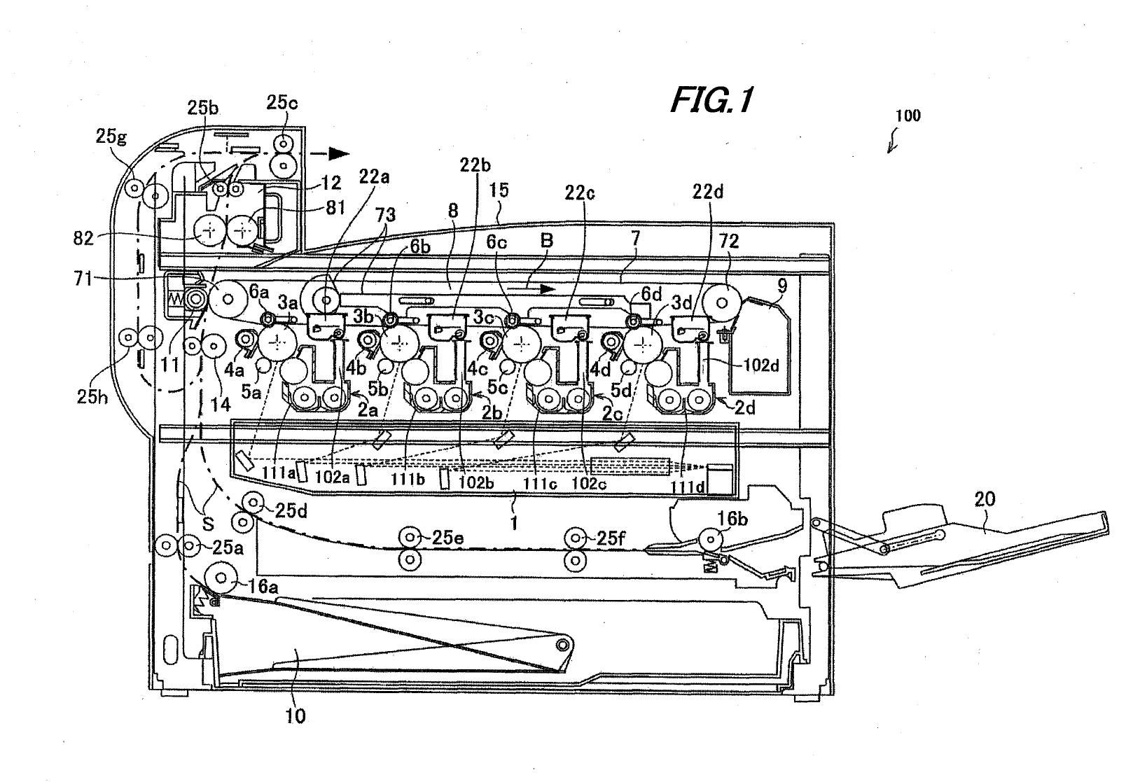

FIG. 1 shows one exemplary embodiment of the present invention, and is an illustrative view showing the overall configuration of an image forming apparatus according to the embodiment of the present invention.

An image forming apparatus 100 of the present embodiment forms an image with toners based on electrophotography, including: as shown in FIG. 1, photoreceptor drums 3a, 3b, 3c and 3d (which may be also called “photoreceptor drums 3” when general mention is made) for forming electrostatic latent images on the surfaces thereof; chargers (charging devices) 5a, 5b, 5c and 5d (which may be also called “chargers 5” when general mention is made) for charging the surfaces of photoreceptor drums 3; an exposure unit (exposure device) 1 for forming electrostatic latent images on the photoreceptor drum 3 surfaces; developing devices 2a, 2b, 2c and 2d (which may be also called “developing devices 2” when general mention is made) for supplying toners to the electrostatic latent images on the photoreceptor drum 3 surfaces to form toner images; toner supply devices 22a, 22b, 22c and 22d (which may be also called “toner supply devices 22” when general mention is made) for supplying toners to developing devices 2; an intermediate transfer belt unit (transfer device) 8 for transferring the toner images from the photoreceptor drum 3 surfaces to a recording medium; and a fixing unit (fixing device) 12 for fixing the toner image to the recording medium.

This image forming apparatus 100 forms a multi-color or monochrome image on a predetermined sheet (recording paper, recording medium) in accordance with image data transmitted from the outside. Here, image forming apparatus 100 may also include a scanner or the like on the top thereof.

To being with, the overall configuration of image forming apparatus 100 will be described.

As shown in FIG. 1, image forming apparatus 100 separately handles image data of individual color components, i.e., black (K), cyan (C), magenta (M) and yellow (Y), and forms black, cyan, magenta and yellow images, superimpose these images of different color components to produce a full-color image.

Accordingly, image forming apparatus 100 includes, as shown in FIG. 1, four developing devices 2 (2a, 2b, 2c and 2d), four photoreceptor drums 3 (3a, 3b, 3c and 3d), four chargers 5 (5a, 5b, 5c and 5d) and four cleaner units 4 (4a, 4b, 4c and 4d) to form images of four different colors. In other words, four image forming stations (image forming portions) each including one developing device 2, one photoreceptor drum 3, one charger 5 and one cleaner unit 4 are provided.

Here, the symbols a to d are used so that ‘a’ represents the components for forming black images, ‘b’ the components for forming cyan images, ‘c’ the components for forming magenta images and ‘d’ the components for forming yellow images. Image forming apparatus 100 includes exposure unit 1, fixing unit 12, a sheet conveyor system S and a paper feed tray 10 and a paper output tray 15.

Charger 5 electrifies the photoreceptor drum 3 surface at a predetermined potential.

As charger 5, other than the contact roller-type charger shown in FIG. 1, a contact brush-type charger, a non-contact type discharging type charger and others may be used.

Exposure unit 1 is a laser scanning unit (LSU) including a laser emitter and reflection mirrors as shown in FIG. 1. Other than the laser scanning unit, arrays of light emitting elements such as EL (electroluminescence) and LED writing heads, may be also used as exposure unit 1. Exposure unit 1 illuminates the photoreceptor drums 3 that have been electrified, in accordance with input image data so as to form electrostatic latent images corresponding to the image data on the surfaces of photoreceptor drums 3.

Developing device 2 visualizes (develops) the electrostatic latent image formed on photoreceptor drum 3 with toner of K, C, M or Y. Arranged over developing devices 2 (2a, 2b, 2c and 2d) are toner transport mechanisms 102a, 102b, 102c and 102d (which may also be called “toner transport mechanisms 102 when general mention is made), toner supply devices 22 (22a, 22b, 22c and 22d) and developing vessels (developer container) 111a, 111b, 111c and 111d (which may also be called “developer vessels 111 when general mention is made).

Toner supply device 22 is arranged on the upper side of developing vessel 111 and stores unused toner (powdery toner). This unused toner is supplied from toner supply device 22 to developing vessel 111 by means of toner transport mechanism 102.

Cleaner unit 4 removes and collects the toner remaining on the photoreceptor drum 3 surface after development and image transfer steps.

Arranged over photoreceptor drums 3 is an intermediate transfer belt unit 8. Intermediate transfer belt unit 8 includes intermediate transfer rollers 6a, 6b, 6c and 6d (which may also be called “intermediate transfer rollers 6 when general mention is made), an intermediate transfer belt 7, an intermediate transfer belt drive roller 71, an intermediate transfer belt driven roller 72, an intermediate transfer belt tensioning mechanism 73 and an intermediate transfer belt cleaning unit 9.

Intermediate transfer rollers 6, intermediate transfer belt drive roller 71, intermediate transfer belt driven roller 72 and intermediate transfer belt tensioning mechanism 73 support and tension intermediate transfer belt 7 to circulatively drive intermediate transfer belt 7 in the direction of an arrow B in FIG. 1.

Intermediate transfer rollers 6 are rotatably supported at intermediate transfer roller fitting portions in intermediate transfer belt tensioning mechanism 73. Applied to each intermediate transfer roller 6 is a transfer bias for transferring the toner image from photoreceptor drum 3 to intermediate transfer belt 7.

Intermediate transfer belt 7 is arranged so as to be in contact with each photoreceptor drum 3. The toner images of different color components formed on photoreceptor drums 3 are successively transferred one over another to intermediate transfer belt 7 so as to form a full-color toner image (multi-color toner image). This intermediate transfer belt 7 is formed of an endless film of about 100 to 150 μm thick, for instance.

Transfer of the toner image from photoreceptor drum 3 to intermediate transfer belt 7 is effected by intermediate transfer roller 6 which is put in contact with the interior side of intermediate transfer belt 7. A high-voltage transfer bias (a high voltage of a polarity (+) opposite to the polarity (−) of the electrostatic charge on the toner) is applied to each intermediate transfer roller 6 in order to transfer the toner image.

Intermediate transfer roller 6 is composed of a shaft formed of metal (e.g., stainless steel) having a diameter of 8 to 10 mm and a conductive elastic material (e.g., EPDM, foamed urethane, etc.,) coated on the shaft surface. Use of this conductive elastic material enables intermediate transfer roller 6 to uniformly apply high voltage to intermediate transfer belt 7. Though in the present embodiment, roller-shaped elements (intermediate transfer rollers 6) are used as the transfer electrodes, brushes etc. can also be used in their place.

The electrostatic latent image formed on each of photoreceptor drums 3 is developed as described above with the toner associated with its color component into a visual toner image. These toner images are laminated on intermediate transfer belt 7, laying one image over another. The thus formed lamination of toner images is moved by rotation of intermediate transfer belt 7 to the contact position (transfer position) between the conveyed paper and intermediate transfer belt 7, and is transferred to the paper by a transfer roller 11 arranged at that position. In this case, intermediate transfer belt 7 and transfer roller 11 are pressed against each other forming a predetermined nip while a voltage for transferring the toner image to the paper is applied to transfer roller 11. This voltage is a high voltage of a polarity (+) opposite to the polarity (−) of the electrostatic charge on the toner.

In order to keep the aforementioned nip constant, either transfer roller 11 or intermediate transfer belt drive roller 71 is formed of a hard material such as metal or the like while the other is formed of a soft material such as an elastic roller or the like (elastic rubber roller, foamed resin roller etc.).

Of the toner adhering to intermediate transfer belt 7 as the belt comes into contact with photoreceptor drums 3, the toner which has not been transferred from intermediate transfer belt 7 to the paper during transfer of the toner image and remains on intermediate transfer belt 7 would cause contamination of color toners at the next operation, hence is removed and collected by intermediate transfer belt cleaning unit 9.

Intermediate transfer belt cleaning unit 9 includes a cleaning blade (cleaning member) that is put in contact with intermediate transfer belt 7. Intermediate transfer belt 7 is supported from its interior side by intermediate transfer belt driven roller 72, at the area where this cleaning blade is put in contact with intermediate transfer belt 7.

Paper feed tray 10 is to stack sheets (e.g., recording paper) to be used for image forming and is disposed under the image forming portion and exposure unit 1. On the other hand, paper output tray 15 disposed at the top of image forming apparatus 100 stacks printed sheets with the printed face down.

Image forming apparatus 100 also includes sheet conveyor system S for guiding sheets from paper feed tray 10 and from a manual feed tray 20 to paper output tray 15 by way of the transfer portion and fixing unit 12. Here, the transfer portion is located between intermediate transfer belt drive roller 71 and transfer roller 11.

Arranged along sheet conveyor system S are pickup rollers 16 (16a, 16b), a registration roller 14, the transfer portion, fixing unit 12 and feed rollers 25 (25a to 25h) and the like.

Feed rollers 25 are a plurality of small-diametric rollers arranged along sheet conveyor system S to promote and assist sheet conveyance. Pickup roller 16a is a roller disposed at the end of paper feed tray 10 for picking up and supplying the paper one sheet at a time from paper feed tray 10 to sheet conveyor system S. Pickup roller 16b is a roller disposed at the vicinity of manual feed tray 20 for picking up and supplying the paper, one sheet at a time, from manual feed tray 20 to sheet conveyor system S. Registration roller 14 temporarily suspends the sheet being conveyed on sheet conveyor system S and delivers the sheet to the transfer portion at such timing that the front end of the sheet meets the front end of the image area on intermediate transfer belt 7.

Fixing unit 12 includes a heat roller 81, a pressing roller 82 and the like. These heat roller 81 and pressing roller 82 rotate while nipping the sheet therebetween. Heat roller 81 is controlled by a controller (not shown) so as to keep a predetermined fixing temperature. This controller controls the temperature of heat roller 81 based on the detection signal from a temperature detector (not shown).

Heat roller 81 fuses, mixes and presses the lamination of color toner images transferred on the sheet by thermally pressing the sheet with pressing roller 82 so as to thermally fix the toner onto the sheet. The sheet with a multi-color toner image (a single color toner image) fixed thereon is conveyed by plural feed rollers 25 to the inversion paper discharge path of sheet conveyor system S and discharged onto paper output tray 15 in an inverted position (with the multi-color toner image placed facedown).

Next, the operation of sheet conveyance by sheet conveyor system S will be described.

As shown in FIG. 1, image forming apparatus 100 has paper feed tray 10 that stacks sheets beforehand and manual feed tray 20 that is used when a few pages are printed out. Each tray is provided with pickup roller 16 (16a, 16b) so that these pickup rollers 16 supply the paper one sheet at a time to sheet conveyor system S.

In the case of one-sided printing, the sheet conveyed from paper feed tray 10 is conveyed by feed roller 25a in sheet conveyor systems to registration roller 14 and delivered to the transfer portion (the contact position between transfer roller 11 and intermediate transfer belt 7) by registration roller 14 at such timing that the front end of the sheet meets the front end of the image area including a lamination of toner images on intermediate transfer belt 7. At the transfer portion, the toner image is transferred onto the sheet. Then, this toner image is fixed onto the sheet by fixing unit 12. Thereafter, the sheet passes through feed roller 25b to be discharged by paper output roller 25c onto paper output tray 15.

Also, the sheet conveyed from manual feed tray 20 is conveyed by plural feed rollers 25 (25f, 25e and 25d) to registration roller 14. From this point, the sheet is conveyed and discharged to paper output tray 15 through the same path as that of the sheet fed from the aforementioned paper feed tray 10.

On the other hand, in the case of dual-sided printing, the sheet that has been printed on the first side and passed through fixing unit 12 as described above is nipped at its rear end by paper discharge roller 25c. Then the paper discharge roller 25c is rotated in reverse so that the sheet is guided to feed rollers 25g and 25h, and conveyed again through registration roller 14 so that the sheet is printed on its rear side and then discharged to paper output tray 15.

Next, the configuration of toner supply device 22 will be specifically described.

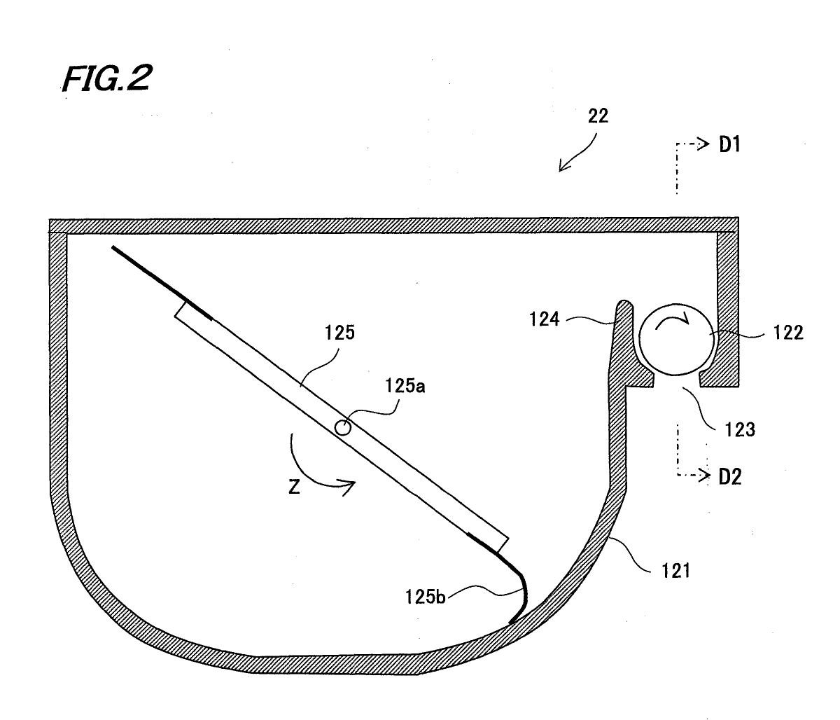

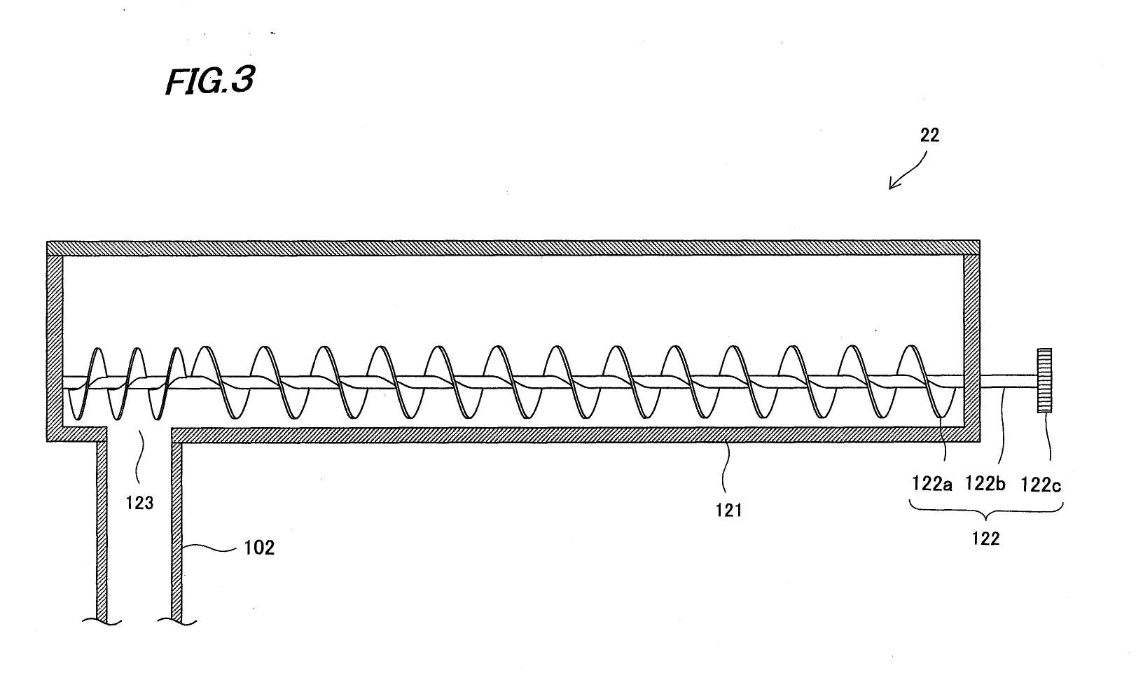

FIG. 2 is a sectional view showing a schematic configuration of the toner supply device that constitutes the image forming apparatus according to the present embodiment. FIG. 3 is a sectional view cut along a plane D1-D2 in FIG. 2.

As shown in FIGS. 2 and 3, toner supply device 22 includes a toner storing container 121, a toner agitator 125, a toner discharger 122 and a toner discharge port 123. Toner supply device 22 is arranged on the upper side of developing vessel 111 (FIG. 1) and stores unused toner (powdery toner). The toner in toner supply device 22 is supplied from toner discharge port 123 to developing vessel 111 (FIG. 1) by means of toner transport mechanism 102 (FIG. 1) as toner discharger (discharging screw) 122 is rotated.

Toner storing container 121 is a container part having a substantially semicylindrical configuration with a hollow interior, rotationally supporting toner agitator 125 and toner discharger 122 to store toner. As shown in FIG. 3, toner discharge port 123 is a substantially rectangular opening disposed under toner discharger 122 and positioned near to the center with respect to the direction of the axis (the axial direction: longitudinal direction) of toner discharger 122 so as to oppose toner transport mechanism 102.

Toner agitator 125 is a plate-like part that rotates about a rotary axis 125a as shown in FIG. 2 and draws up and conveys the toner stored inside toner storing container 121 toward toner discharger 122 whilst agitating the toner. Toner agitator 125 has toner scooping parts 125b at both the ends thereof. Toner scooping part 125b is formed of a polyethylene terephthalate (PET) sheet having flexibility and is attached to either end of toner agitator 125.

Toner discharger 122 dispenses the toner in toner storing container 121 from toner discharge port 123 to developing vessel 111, and is formed of a screw auger having a toner conveyor blade 122a and a toner discharger rotary shaft 122b and a toner discharger rotating gear 122c, as shown in FIG. 3. Toner discharger 122 is rotationally driven by an unillustrated toner discharger drive motor. As to the direction of the screw auger, it is designed so that toner can be conveyed from both ends of toner discharger 122 with respect to the axial direction thereof toward toner discharge port 123.

Provided between toner discharger 122 and toner agitator 125 is a toner discharger partitioning wall 124. This wall makes it possible to keep and hold the toner scooped by toner agitator 125 in an appropriate amount around toner discharger 122.

As shown in FIG. 2, when toner agitator 125 rotates in the direction of arrow Z to agitate and scoop up the toner toward toner agitator 122, toner scooping parts 125b rotate as they are deforming and sliding over the interior wall of toner storing container 121 due to the flexibility thereof, to thereby supply the toner toward the toner discharger 122 side. Then, toner discharger 122 turns so as to lead the supplied toner to toner discharge port 123.

Next, the characteristic configuration of image forming apparatus 100 will be described with reference to the drawings.

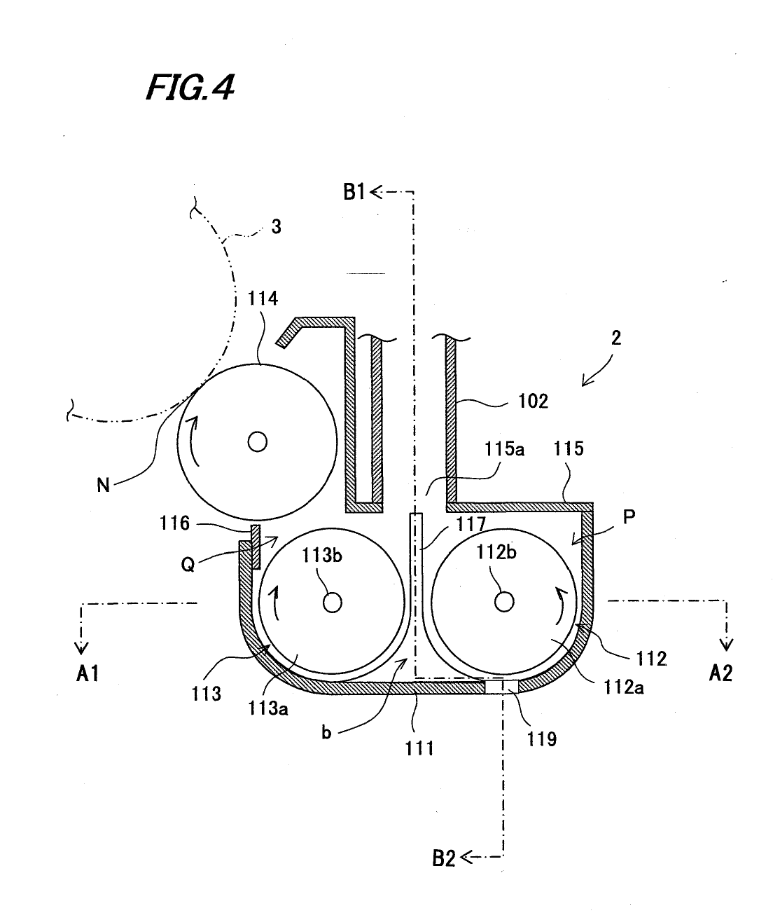

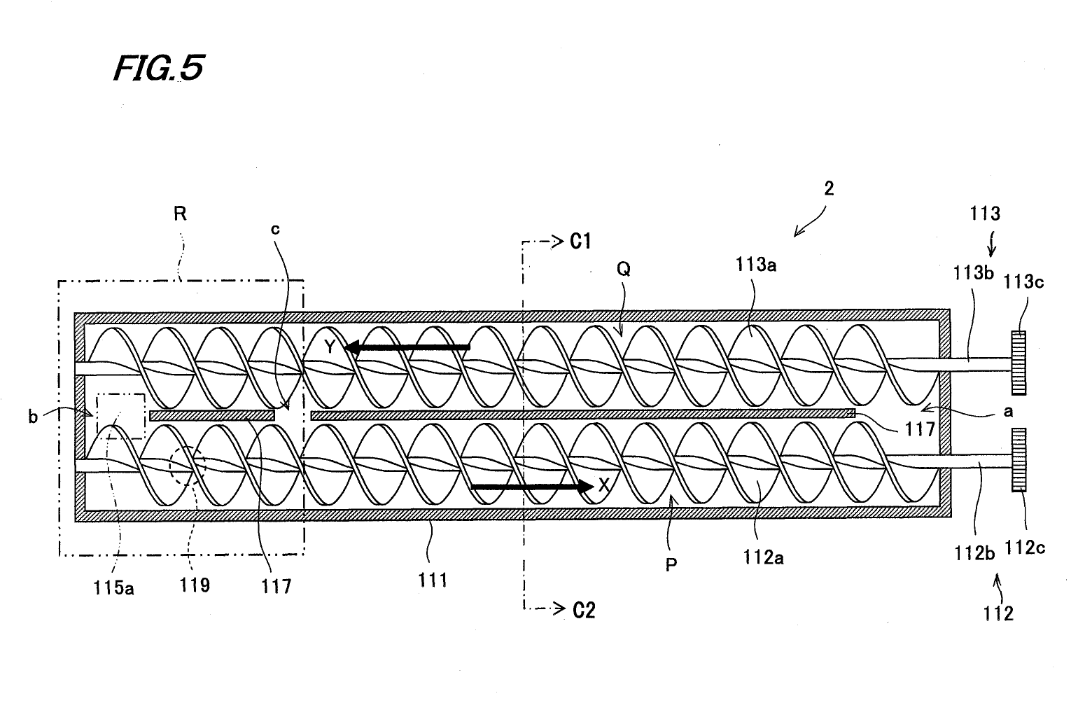

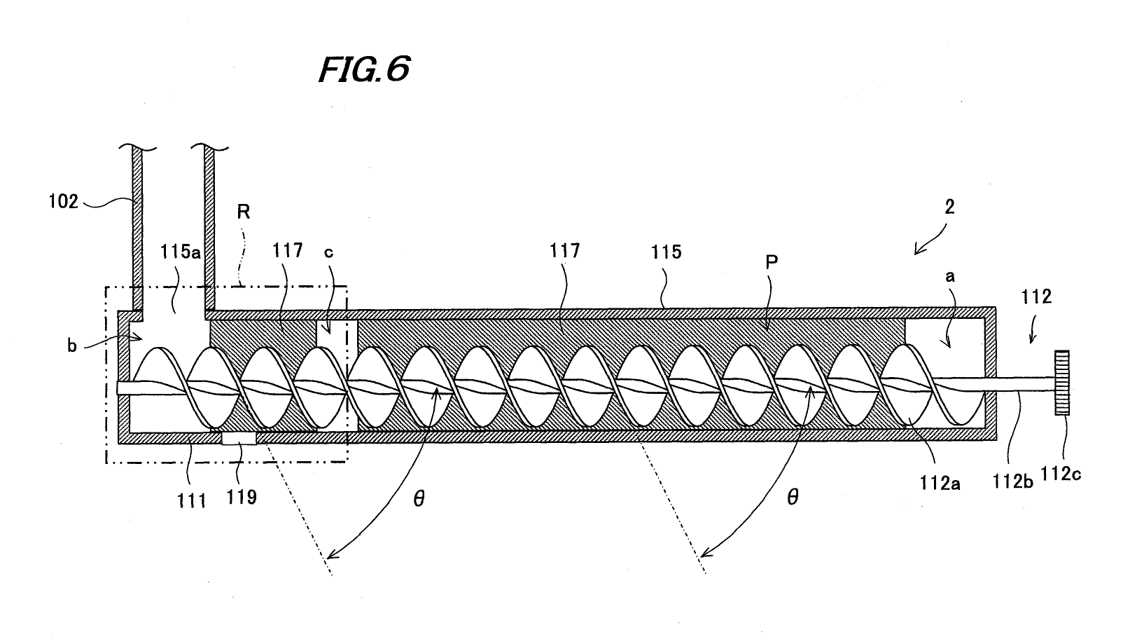

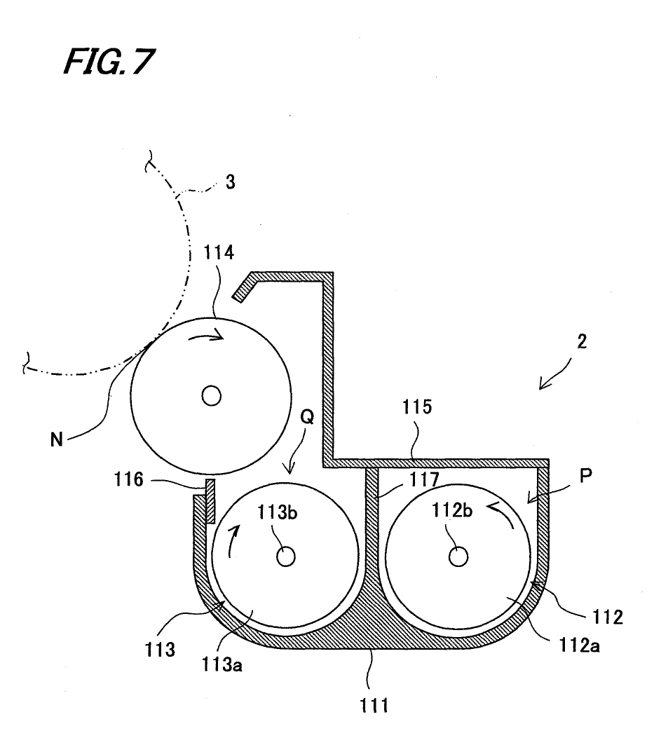

FIG. 4 is a sectional view showing the configuration of developing device 2 according to the present embodiment, FIG. 5 is a sectional view cut along a plane A1-A2 in FIG. 4, FIG. 6 is a sectional view cut along a plane B1-B2 in FIG. 4, and FIG. 7 is a sectional view cut along a plane C1-C2 in FIG. 5.

Image forming apparatus 100 of the present embodiment includes: as shown in FIGS. 1 and 4, developing device 2 having a toner supply port 115a through which supplied toner is input into developing vessel (developer container) 111 for storing the developer; toner supply device 22 for supplying toner to developing device 2; a toner supply detecting sensor 119 (FIG. 4) for detecting toner supply to the developer container; a toner concentration controller that directs toner supply device 22 to supply toner into developing device 2 when the toner concentration of the developer in developing device 2 becomes lower than a predetermined level; and a toner empty detector that determines that toner in toner supply device 22 is used up when toner supply detecting sensor 119 does not detect any effect of toner supply after toner supply was directed by the toner concentration controller.

Further, as shown in FIGS. 4 to 6, developing device 2 has a pre-agitating section R (FIGS. 5 and 6) for agitating and mixing supplied toner with the developer inside developing vessel 11. Toner supply port 115a is arranged in this pre-agitating section R and toner supply detecting sensor 119 is disposed at the bottom of pre-agitating section R near toner supply port 115a.

To begin with the characteristic developing device 2 of the present embodiment will be described with reference to the drawings.

As shown in FIG. 4, developing device 2 has a developing roller (developer bearer) 114 arranged inside developing vessel 111 so as to oppose photoreceptor drum 3 and supplies toner from developing roller 114 to the photoreceptor drum 3 surface to visualize (develop) the electrostatic latent image formed on the surface of photoreceptor drum 3.

As shown in FIGS. 4 to 6, developing device 2, other than developing roller 114, further includes developing vessel 111, a developing vessel cover 115, toner supply port 115a, a doctor blade 116, a first conveying member 112, a second conveying member 113, pre-agitating section R (FIGS. 5 and 6), a partitioning plate (partitioning wall) 117 and toner supply detecting sensor 119.

Developing vessel 111 is a receptacle for holding a dual-component developer that contains a toner and a carrier (which will be simply referred to hereinbelow as “developer”). Developing vessel 111 includes developing roller 114, first conveying member 112, second conveying member 113 and the like. Here, the carrier of the present embodiment is a magnetic carrier presenting magnetism.

Arranged on the top of developing vessel 111 is removable developing vessel cover 115, as shown in FIGS. 4 and 6. This developing vessel cover 115 is formed with toner supply port 115a for supplying unused toner into pre-agitating section R in developing vessel 111.

Arranged in developing vessel 111 is partitioning plate 117 between first conveying member 112 and second conveying member 113. Partitioning plate 117 is extended parallel to the axial direction (the direction in which each rotary axis is laid) of first and second conveying members 112 and 113. The interior of developing vessel 111 is divided by partitioning plate 117 into two sections, namely, a first conveying passage P with first conveying member 112 and a second conveying passage Q with second conveying member 113.

Partitioning plate 117 is arranged so that its ends, with respect to the axial direction of first and second conveying members 112 and 113, are spaced from respective interior wall surfaces of developing vessel 111. Hereby, developing vessel 111 has communicating paths that communicate between first conveying passage P and second conveying passage Q at around both axial ends of first and second conveying members 112 and 113. In the following description, as shown in FIG. 5, the communicating path formed on the downstream side with respect to the direction of arrow X is named first communicating path a and the communicating path formed on the downstream side with respect to the direction of arrow Y is named second communicating path b.

As shown in FIGS. 5 and 7, first conveying member 112 and second conveying member 113 are arranged and rotated in opposite directions so that their axes are parallel to each other with their peripheral sides opposing each other across partitioning plate 117. That is, as shown in FIG. 5, first conveying member 112 conveys the dual-component developer in the direction of arrow X while second conveying member 113 conveys the developer in the direction of arrow Y, which is the opposite to the direction of arrow X.

As shown in FIG. 5, first conveying member 112 is composed of a screw auger formed of a first helical conveying blade 112a and a first rotary shaft 112b, and a gear 112c. As shown in FIG. 5, second conveying member 113 is composed of a screw auger formed of a second helical conveying blade 113a and a second rotary shaft 113b, and a gear 113c. First and second conveying members 112 and 113 are rotationally driven by a drive means (not shown) such as a motor etc., to agitate and convey the developer.

As shown in the sectional view of FIG. 6, first conveying member 112 is formed so that the angle formed between first rotary shaft 112b and the peripheral edge of first conveying blade 112a, or the inclined angle θ of the helical blade, falls within the range of 30 degrees to 60 degrees. Second conveying member 113 also has the same configuration as that of first conveying member 112.

Specifically, when the inclined angle θ of the helical blade of first conveying member 112 is equal to or greater than 30 degrees and equal to smaller than 60 degrees, the force of first conveying member 112 for agitating the developer in the rotational direction is so strong that the so-called “floating toner” phenomenon, the phenomenon of the supplied toner being conveyed floating over the developer, is unlikely to occur. Accordingly, it is possible for toner supply detecting sensor 119 to detect the effect of toner supply with precision.

On the other hand, when the inclined angle θ of the helical blade is less than 30 degrees, the speed of the developer being conveyed by first conveying member 112 is low so that the developer is abraded quickly. When the inclined angle θ of the helical blade exceeds 60 degrees, the speed of the developer being conveyed by first conveying member 112 becomes too high so that the floating toner phenomenon is prone to occur.

As shown in FIG. 5, pre-agitating section R is mainly formed of second communicating path b that connects between first conveying passage P and second conveying passage Q, first conveying passage P, second conveying passage Q and partitioning plate 117 near the second communicating path b.

A third communicating path c that creates communication between first conveying passage P and second conveying passage Q is formed in partitioning plate 117 on the pre-agitating section R side.

The third communication path c is formed close to second communication path b in partition plate 117. Toner supply detecting sensor 119 is disposed on the base of first conveying passage P between second communicating path b and third communicating path c.

Toner supply port 115a is disposed over second communicating path b in pre-agitating section R. Arranged at the bottom of pre-agitating section R around and under toner supply port 115a is toner supply detecting sensor 119.

First conveying member 112 and second conveying member 113 are partly arranged in pre-agitating section R so as to provide a function of a pre-agitating structure for conveying and agitating the developer inside pre-agitating section R. That is, the helical blades of the part of first conveying member 112 and the part of second conveying member 113 that serve as the pre-agitating structure inside pre-agitating section R are also configured so that the inclined angle θ of the peripheral edge of each blade relative to the axial direction of rotary shaft 112b or 113b is specified to fall within the range from 30 degrees to 60 degrees.

Developing roller 114 (FIG. 4) is a rotating magnet roller which is rotationally driven about its axis by an unillustrated driver, draws up and carries the developer in developing vessel 111 on the surface thereof and supplies toner from the developer supported on the surface thereof to photoreceptor drum 3.

The developer conveyed by developing roller 114 comes in contact with photoreceptor drum 3 in the area where the distance between developing roller 114 and photoreceptor drum 3 becomes minimum. This contact area is designated as a developing nip portion N. As a developing bias is applied to developing roller 114 from an unillustrated power source that is connected to developing roller 114, toner is supplied in developing nip portion N, from the developer on the developing roller 114 surface to the electrostatic latent image on the photoreceptor drum 3 surface.

Arranged close to the surface of developing roller 114 is a doctor blade (layer thickness limiting blade) 116.

Doctor blade 116 is a rectangular plate-shaped member that is extended parallel to the axial direction of developing roller 114, disposed vertically below developing roller 114 and supported along its longitudinal side by developing vessel 111 so that its opposite longitudinal side is spaced from the developing roller 114 surface. This doctor blade 116 may be made of stainless steel, or may be formed of aluminum, synthetic resin or the like.

Concerning the attachment of toner supply detecting sensor 119, with regard to the horizontal direction (developer conveying direction), the sensor is attached at a position near and on the downstream side of toner supply port 115a with respect to the developer conveying direction (the direction of arrow X) while with regard to the vertical direction, the sensor is attached on the base of developing vessel 111 vertically below first conveying member 112, as shown in FIGS. 4 to 6. That is, toner supply detecting sensor 119 is attached to the base of first conveying passage P with its sensor face exposed to the interior of developing vessel 111.

Toner supply detecting sensor 119 is electrically connected to an unillustrated toner concentration controller. Toner supply detecting sensor 119 may use general-purpose detection sensors. Examples include transmitted light detecting sensors, reflected light detecting sensors, magnetic permeability detecting sensors, etc. Of these, magnetic permeability detecting sensors are preferable.

The magnetic permeability detecting sensor is connected to an unillustrated power supply. This power supply applies to the magnetic permeability detecting sensor the drive voltage for driving the magnetic permeability detecting sensor and the control voltage for outputting the detected result of toner concentration to the controller. Application of voltage to the magnetic permeability detecting sensor from the power supply is controlled by the controller. The magnetic permeability detecting sensor is a sensor of a type that receives application of a control voltage and outputs the detected result of toner concentration as an output voltage. Since, basically, the sensor is sensitive in the middle range of the output voltage, the applied control voltage is adjusted so as to produce output voltage around that range. Magnetic permeability detecting sensors of this kind are found on the market, examples including TS-L, TS-A and TS-K (all of these are trade names of products of TDK Corporation).

Now, conveyance of the developer in developing vessel 111 of developing device 2 will be described.

As shown in FIG. 4, the toner stored in toner supply device 22 is transported into developing vessel 111 by way of toner transport mechanism 102 and toner supply port 115a, whereby toner is supplied to developing vessel 111.

In developing vessel 111, first conveying member 112 and second conveying member 113 are rotationally driven by a drive means (not shown) such as a motor etc., to convey the developer. More specifically, in first conveying passage P, the developer is agitated and conveyed in the direction of arrow X (FIG. 5) by first conveying member 112 to reach first communicating path a. The developer reaching first communicating path a is conveyed through first communicating path a to second conveying passage Q.

On the other hand, in second conveying passage Q, the developer is agitated and conveyed in the direction of arrow Y (FIG. 5) by second conveying member 113 to reach second communicating path b. Then, the developer reaching second communicating path b is conveyed through second communicating path b to first conveying passage P.

That is, first conveying member 112 and second conveying member 113 agitate the developer while conveying it in opposite directions.

In this way, the developer is circulatively moving in developing vessel 111 along first conveying passage P, first communicating path a, second conveying passage Q and second communicating path b, in this mentioning order. In this arrangement, the developer is carried and drawn up by the surface of rotating developing roller 114 while being conveyed in second conveying passage Q, and the toner in the drawn up developer is continuously consumed as moving toward photoreceptor drum 3.

In order to compensate for this consumption of toner, unused toner is supplied from toner supply port 115a into pre-agitating section R. The supplied toner is agitated and mixed in pre-agitating section R with the previously existing developer.

In the present embodiment, pre-agitating section R is provided on one end (on the second communicating path b side) of developing vessel 111, so that the developer conveyed from second conveying passage Q to first conveying passage P through second communicating path b is conveyed and agitated whilst being mixed in pre-agitating section R with the toner added from toner supply port 115a.

In pre-agitating section R, part of the developer conveyed by first conveying member 112 enters second conveying passage Q through third communicating path c, then is further agitated with the developer that has been conveyed by second conveying member 113, and passes through second communicating path b, returning to first conveying passage P, as shown in FIG. 5.

On the other hand, part of the developer conveyed by second conveying member 113 enters first conveying passage P through third communicating path c, then is conveyed whist being agitated with the developer that has been conveyed by first conveying member 112.

The toner supplied from toner supply port 115a to second communicating path b is conveyed with the developer that has been conveyed by second conveying member 113 into first conveying passage P, and further conveyed whilst being agitated by first conveying member 112.

At this time, part of the added toner enters second conveying passage Q through third communicating path c, is agitated once again with the developer that has been conveyed by second conveying member 113, and conveyed into first conveying passage P, passing through second communicating path b. In this way, it is possible to mix up the supplied toner with the developer in an improved manner since the added toner is conveyed whilst being further agitated with the previously existing developer.

Next, the toner concentration controller and the toner empty determiner in image forming apparatus 100 will be specifically described.

The toner concentration controller may use a general method. For example, control using a toner concentration detecting sensor, control based on patch image density, control depending on dot counting and the like can be mentioned. Of these, control depending on dot counting is preferable.

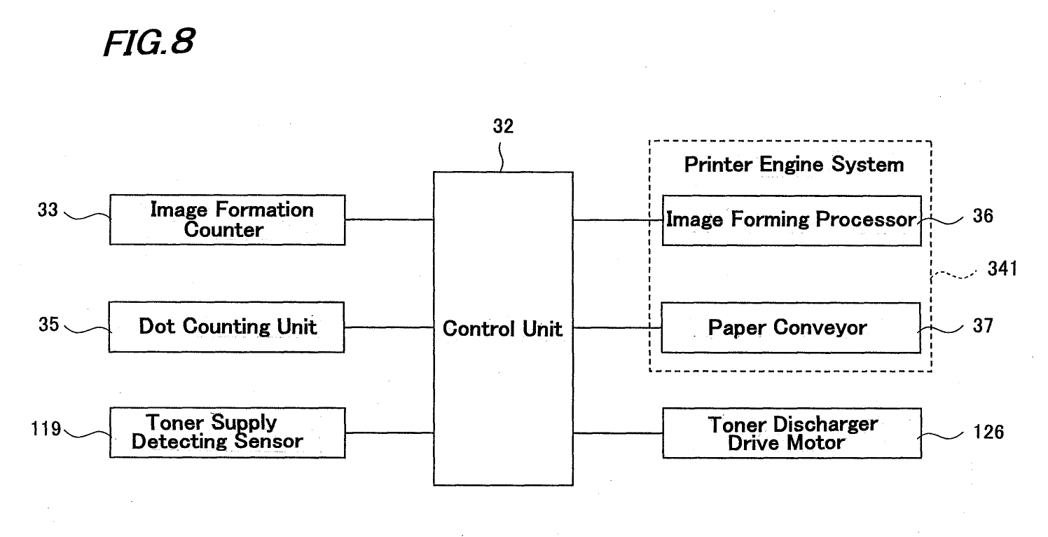

As shown in FIG. 8, image forming apparatus 100 includes a dot counting unit (dot counter) 35 for counting dots of data for image data to be transmitted to exposure unit 1. Toner concentration controller (control unit 32) directs toner supply device 22 to supply toner to developing device 2 in accordance with the counted dots of data from dot counting unit 35.

If toner supply detecting sensor 119 does not detect any effect of toner supply after the toner concentration controller directed toner supply device 22 to supply toner to developing device 2, toner empty determiner (control unit 32) determines that no toner has been supplied from toner supply device 22 to developing device 2, or that no toner remains in toner supply device 22 (toner empty).

Now, the configuration of the control system of image forming apparatus 100 will be described based on a block diagram.

FIG. 8 is a block diagram showing a configuration of the control system in the image forming apparatus of the present embodiment.

As shown in FIG. 8, image forming apparatus 100 includes an image formation counter 33 for counting the total number of image forming operations, dot counting unit 35 for detecting the total count of pixels of an image formed on photoreceptor drum 3, a toner supply detecting sensor 119 for detecting the magnetic permeability of the developer near the toner supply port, a printer engine system 341 including an image forming processor 36 and a paper conveyor 37, a toner discharger drive motor 126 for driving toner discharger 122

that supplied toner to developing vessel 111 and control unit 32 for controlling these.

In image forming apparatus 100, toner concentration controller is mainly set up with control unit 32, and controls toner discharger drive motor 126 depending on the dot data from dot counting unit 35 as shown in FIG. 8.

Dot counting unit 35 is to detect the total of the number of pixels of an image (electrostatic latent image) formed on photoreceptor drum 3 corresponding to the printed image, and stores the total count of the pixels of the images to be printed and the total count of the images that have been printed heretofore as dot count values and inputs the count values to control unit 32. From the total count of the pixels of the images detected by dot counting unit 35, the amount of toner consumed for image forming can be estimated.

Control unit 32 determines the amount of toner to be consumed for the current image forming, depending on the dot count value, and directs toner discharger drive motor 126 to rotate and drive toner discharger 122 of toner supply device 22 in accordance with the determined amount of toner.

In this way, toner corresponding to the amount of toner consumed from developing device 2 (developing vessel 111) is supplied from toner supply device 22 into developing device 2 (developing vessel 111).

In image forming apparatus 100, the toner empty determiner is mainly set up with control unit 32, and determines that no toner remains in toner supply device 22 (toner empty) based on the detected result of toner supply detecting sensor 119, as shown in FIG. 8. Though in the present embodiment, the toner concentration controller and the toner empty determiner are set up with common control unit 32, it goes without saying that these functions can be set up with different control units.

In the present embodiment, the toner concentration of the developer in pre-agitating section R in developing vessel 111 is continuously monitored by toner supply detecting sensor 119, and if toner supply detecting sensor 119 has not detected any effect of toner supply even after toner supply was directed to the toner concentration controller, control unit 32 determines the occurrence of toner empty.

Next, toner supply to developing device 2 in image forming apparatus 100 of the present embodiment will be described.

Toner supply to developing device 2 in image forming apparatus 100 is performed by the toner concentration controller directing toner supply device 22 to supply toner to developing device 2 when the toner concentration of the developer in developing vessel 111 of developing device 2 has lowered and becomes lower than a predetermined level.

Toner supply into developing vessel 111 is detected by toner supply detecting sensor 119.

Since toner supply detecting sensor 119 is disposed on the base in pre-agitating section R under toner supply port 115a, if toner is added to the developer from toner supply port 115a, it is possible to detect change of the magnetic permeability of the developer at once. That is, it is possible to immediately confirm whether or not toner supply from toner supply device 22 is performed.

Further, since the pressure on the developer becomes maximum at the bottom of the pre-agitating section, voids are unlikely to form inside the developer. Accordingly, provision of toner supply detecting sensor 119 on the base in pre-agitating section R makes it possible for the toner supply detecting sensor to perform precise detection of toner supply.

Accordingly, when the toner concentration controller directed toner supply device 22 to perform toner supply and no change of the magnetic permeability of the developer has been detected by toner supply detecting sensor 119, control unit 32 can determine that no toner has been supplied from toner supply device 22. That is, it is possible for the empty determiner to immediately determine that the toner in toner supply device 22 is used up (toner empty).

A specific way of determining the occurrence of toner empty is performed by calculating the difference or the ratio between successive outputs from toner supply detecting sensor 119 when the outputs change in linkage with a toner supply signal from the apparatus body. For example, when the sensor outputs before and after toner supply are given as B and A, respectively, the difference Δ(B−A) is calculated for each operation of toner supply.

When toner supply device 22 has a sufficient amount of toner left, a large amount of toner falls in a stable manner. Hence the difference Δ(B−A) presents a large value. On the other hand, when the remaining amount of toner is low, the difference Δ(B−A) presents a small value, approaching to “0”. When the difference Δ(B−A) is lower than a predetermined level (threshold), the occurrence of toner empty is detected.

Here, in order to detect a change in the output from toner supply detecting sensor 119, a ratio (B/A) may also be used instead of the difference Δ(B−A).

According to the present invention having the configuration described heretofore, since toner supply port 115a is arranged in pre-agitating section R of developing device 2 and toner supply detecting sensor 119 is laid out on the bottom of pre-agitating section R under the vicinity of toner supply port 115a, it is possible to detect the levels of toner concentration before and after a supply of toner within a short period of time before and after toner supply. As a result, it is possible to detect a change of the magnetic permeability at once when toner is supplied from toner supply device 22.

Accordingly, in a case where toner supply detecting sensor 119 provided in pre-agitating section R has detected no change in magnetic permeability when the toner concentration in the developer inside developing device 2 had become lower than the predetermined level and the toner concentration controller directed toner supply device 22 to supply toner, the empty determiner is able to promptly conclude that the toner in toner supply device is used up (toner empty). With this arrangement, it is possible to prevent the occurrence of carrier adherence to photoreceptor drum 3 due to a decrease in toner concentration when a toner image is formed on photoreceptor drum 3.

Further, according to the present embodiment, since part of first conveying member 112 and second conveying member 113 is constructed so that the inclined angle θ of each helical blade falls within the range from 30 degrees to 60 degrees, the force of the preliminary agitating structure for agitating the developer in the rotational direction is so strong that the so-called “floating toner” phenomenon, the phenomenon of the added toner being conveyed floating over the developer, is unlikely to occur. Accordingly, it is possible for toner supply detecting sensor 119 to detect change in magnetic permeability of the developer with precision even right after toner supply.

Though, in the present embodiment, toner supply port 115a is disposed over second communicating path b in pre-agitating section R, the position of toner supply port 115a should not be limited to the configuration of this embodiment as long as toner supply port 115a is provided in pre-agitating section R while toner supply detecting sensor 119 is arranged under the vicinity of toner supply port 115a.

Further, though in the present embodiment, part of first conveying member 112 and part of second conveying member 113 are arranged so as to provide a function of a pre-agitating structure in pre-agitating section R, the present invention should not be limited to this. For example, the function of the pre-agitating structure may be given separately from the arrangement of first conveying member 112 and second conveying member 113.

Though the above embodiment was described taking an example in which the image forming apparatus of the present invention is applied to image forming apparatus 100 shown in FIG. 1, as long as it is an image forming apparatus in which the toner concentration of the developer in the developing device is controlled by supplying toner from a toner supply device, the invention can be developed to any other image forming apparatus and the like, not limited to the image forming apparatus and copier described above.

Having described heretofore, the present invention is not limited to the above embodiment, various changes can be made within the scope of the appended claims. That is, any embodied mode obtained by combination of technical means modified as appropriate without departing from the spirit and scope of the present invention should be included in the technical art of the present invention.

What is claimed is:

1. An image forming apparatus comprising:
a developing device;
a toner supply device that supplies toner to the developing device;
a toner concentration controller that directs the toner supply device to perform toner supply to the developing device; and,
a toner empty determiner for determining that no toner is left in the toner supply device, characterized in that
the developing device comprises:
a developer container for storing a developer including the toner and a magnetic carrier;
a developer conveying assembly disposed inside the developer container for circulatively conveying the developer whilst agitating;
a developing roller for supplying the toner contained in the developer to a photoreceptor drum;
a toner supply port that leads the toner supplied from the toner supply device into the developer container;
a preliminary agitating structure for agitating and mixing the supplied toner; and,
a toner supply detecting sensor for detecting whether the toner is supplied from the toner supply device into the developer container,
the toner concentration controller gives directions to perform the toner supply when the toner concentration of the developer in the developing device has become lower than a predetermined level,
the toner empty determiner determines that the toner supply device has no toner left therein when no effect of the toner supply is detected by the toner supply detecting sensor after the toner supply is directed by the toner concentration controller, and
the toner supply detecting sensor is disposed in the preliminary agitating section.

2. The image forming apparatus according to claim 1, wherein the toner supply detecting sensor detects the magnetic permeability of the developer residing in the preliminary agitating section.

3. The image forming apparatus according to claim 1, wherein the developer container includes a first conveying passage and a second conveying passage that are sectioned by a partitioning wall and arranged to communicate with each other at both ends of the partitioning wall,
the developer conveying assembly includes a first conveying member and second conveying member that are arranged in the first convening passage and second conveying passage, respectively, agitate and circulatively convey the developer in the first conveying passage and second conveying passage, in opposite directions to each other,
the developing roller supplies the toner inside the second conveying passage to the photoreceptor drum,
the preliminary agitating section is arranged at a communicating portion that provides communication between the first conveying passage and the second conveying passage,
the preliminary agitating section includes a preliminary agitating structure that conveys the developer whilst agitating, and
the toner supply detecting sensor is disposed at the bottom of the preliminary agitating section under the toner supply port.

4. The image forming apparatus according to claim 2, wherein the developer container includes a first conveying passage and a second conveying passage that are sectioned by a partitioning wall and arranged to communicate with each other at both ends of the partitioning wall,
the developer conveying assembly includes a first conveying member and second conveying member that are arranged in the first convening passage and second conveying passage, respectively, agitate and circulatively convey the developer in the first conveying passage and second conveying passage, in opposite directions to each other,
the developing roller supplies the toner inside the second conveying passage to the photoreceptor drum,
the preliminary agitating section is arranged at a communicating portion that provides communication between the first conveying passage and the second conveying passage,
the preliminary agitating section includes a preliminary agitating structure that conveys the developer whilst agitating, and
the toner supply detecting sensor is disposed at the bottom of the preliminary agitating section under the toner supply port.

5. The image forming apparatus according to claim 3, wherein the preliminary agitating structure includes a screw auger having a rotary shaft and a helical blade that is formed so that the inclined angle relative to the axial direction of the rotary shaft is specified to fall within the range of 30 degrees to 60 degrees.

6. The image forming apparatus according to claim 4, wherein the preliminary agitating structure includes a screw auger having a rotary shaft and a helical blade that is formed so that the inclined angle relative to the axial direction of the rotary shaft is specified to fall within the range of 30 degrees to 60 degrees.

7. The image forming apparatus according to claim 1, further comprising a dot counter for counting dots of data corresponding to image data to be transmitted to the exposure device for forming an electrostatic latent image on the photoreceptor drum surface,
wherein the toner concentration controller directs the toner supply device to supply toner to the developing device depending on the count of the dots of data from the dot counter.
